(19) United States
(12) Patent Application Publication
(10) Pub. No.: US 2018/0099425 A1
(43) Pub. Date: Apr. 12, 2018

(54) UTENSIL FOR MAKING CHOCOLATE FLOWERS

(71) Applicant: John Nikolopoulos, Brooklyn, NY (US)

(72) Inventor: John Nikolopoulos, Brooklyn, NY (US)

(21) Appl. No.: 15/287,514

(22) Filed: Oct. 6, 2016

(51) Int. Cl. B26B 9/02; B26B 5/00; A23G 1/04; A23G 3/28

(52) U.S. Cl. CPC B26B 9/02; A23G 3/28; A23G 1/04; B26B 5/00

(57) ABSTRACT

An inexpensive, cost-effective utensil with interchangeable blades. The utensil allows the user to simply, quickly, and inexpensively create chocolate flowers on cakes of varying sizes and shapes in commercial bakery or home environment.

This invention was not made pursuant to any federally-sponsored research and/or development.

### INVENTOR

John Nikolopoulos of Brooklyn, N.Y.

### BACKGROUND

This invention relates to a kitchen, baking, pastry and chocolate utensil, having a curved blade attached to a handle, particularly for making chocolate flowers on cakes and in other confectionary applications. Using the utensil of the present invention, any baker or pastry chef can make chocolate flowers on cakes with a little bit of practice. Although primarily aimed at commercial bakery use, the utensil for making chocolate flowers of the present invention can also be successfully used in small bakery and pastry shops, specialty shops, or at home, to make chocolate flowers and/or decorate fresh cakes of different shapes and sizes.

Cakes are popular with children and adults alike, and are sold as for every day enjoyment and special events, such as celebrations, holidays, graduations, and birthdays. Many cakes with fanciful and vanity designs and shapes are frequently created for birthdays or event-themed decorations. The utensil of the present invention allows the user to decorate the cakes beautifully by making and shaping chocolate flowers on the cakes. The utensil also has other functions: it can be used as a miscellaneous cutter with its knife blade and scraper, which is essentially a serrated blade, and it can be used as a peeler, grater or zester with the built-in peeler.

### DESCRIPTION OF PRIOR ART

A number of combination utensils are known in the art, such as a multifunction kitchen tool having a handle, a folding knife blade, a peeler and a number of other retractable tools (U.S. Publication No 2015/0342412), a multi-purpose kitchen utensil that has a handle to which a spatula with a peeler and a number of retractable tools are attached (U.S. Publication No. 2005/0138736), as well as other kitchen utensils. However, none of the existing utensils have a curved blade of the utensil of the present invention suitable for making chocolate flowers.

What is needed is an easy-to-use, inexpensive-to-make, and easy-to-clean utensil for creating chocolate flowers on cakes of varying shapes and sizes, and with whatever chocolate ingredients the users want (dark, white of milk chocolate, for example). The chocolate flowers will enhance and may be used on any kind of cake, from the simple one-level plain vanilla cake, to the multi-layer gourmet chocolate cake with walnuts and strawberries—any number of varieties, layers, and ingredients can be implemented in cakes of different sizes and shapes and topped off with beautiful chocolate flowers.

### SUMMARY

This invention meets the current need for such a utensil. A combination utensil for cake chefs is provided. The preferred embodiment of the utensil is a handle of a specific shape, with a curved blade attached to the handle, and further having a cutting edge on one side of the blade, and curls and a scraper on the other side of the blade, as well as a peeler on the substantially flat surface of the blade where the blade curves.

The blade of the utensil is preferably removably attachable to the handle for the ease of removing the blade and cleaning the utensil, as well as to enable removable and replaceable blades of different sizes that may be used to create chocolate flowers of different sizes and shapes. Such attachment means may include screws in the handle passing through the tang of the blade, a removable cap that may be screwed onto the handle and through which the tang of the blade passes, or other means known in the art. However, the blade of the utensil may be permanently or semi-permanently attached to the handle, by being molded, riveted or pinned into the handle.

### DRAWINGS

These features, aspects and advantages of the utensil for making chocolate flowers on cakes will become further understood with reference to the following description and accompanying drawings where

FIG. 1 is a perspective view of the utensil of the present invention;

FIG. 2 is a front view of an alternative embodiment of the utensil of the present invention;

FIG. 3 is a back view of the of the alternative embodiment of the utensil of the present invention illustrated in FIG. 2;

FIG. 4 is a left side view of the utensil of FIG. 2;

FIG. 5 is a right side view of the utensil of FIG. 2;

FIG. 6 is a top down view of the utensil of FIG. 1, with the peeler visible;

FIG. 7 is a bottom view of the of the utensil of FIG. 1 with the peeler visible from the other side;

FIG. 8 is a partial cross-sectional view of the utensil of the present invention illustrated in FIG. 6 (peeler); and

FIG. 9 is a partial cross-sectional view of the utensil of the present invention illustrated in FIG. 7 (peeler and cutting edge).

### DESCRIPTION

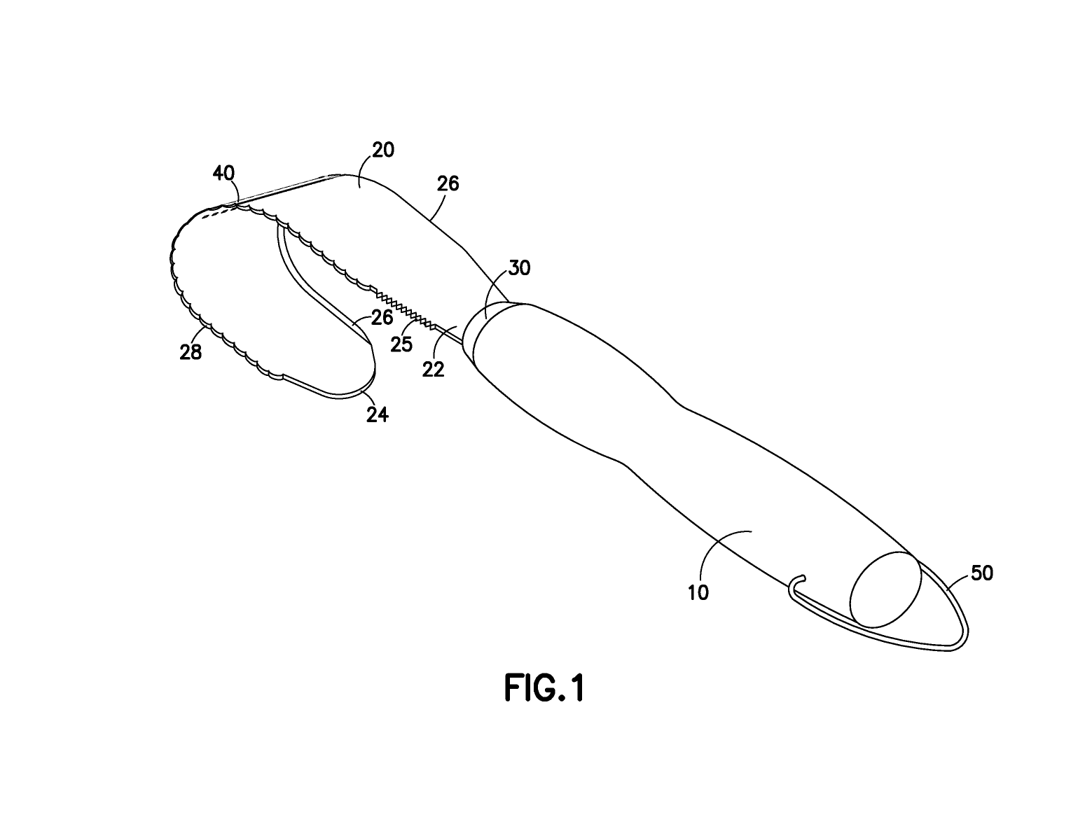

As illustrated in FIG. 1, the utensil of the present invention comprises a handle 10 and a blade 20 connected to the handle 10, which blade 20 has a base 22 and an end 24. The blade 20 is preferably removable from the handle 10 for easy cleaning of the utensil 10 and replacement of blade 20 with a fresh blade 20 or a blade 20 having different dimensions for creating different-size chocolate flowers. In the embodiment illustrated in FIG. 1, the blade 20 is held in place in the handle 10 by the cap 30, which may be a slide-on or screw-on cap. The tang 21 of blade 20 slides through the cap 30 and into the handle 10, and the cap 30 is then positioned (slid onto or screwed onto) the cooperating end of the handle 10 through which the tang 21 of the blade 20 is inserted.

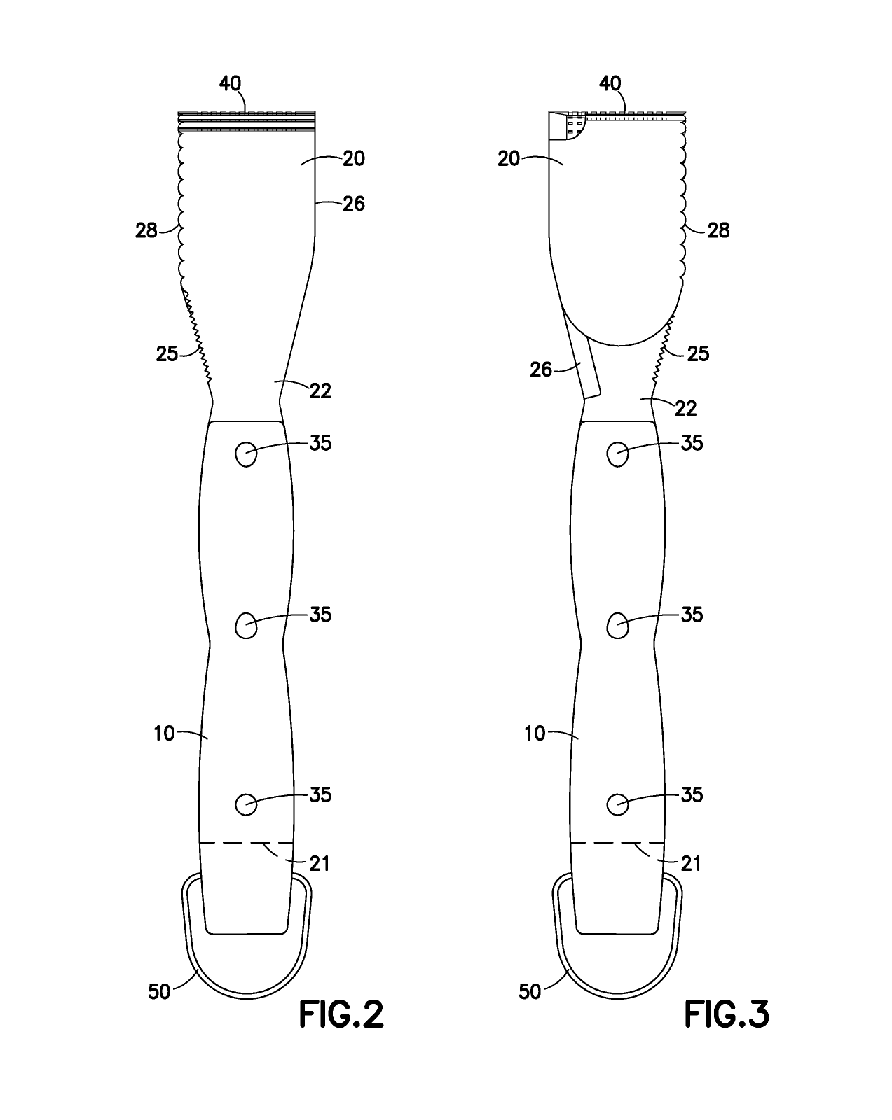

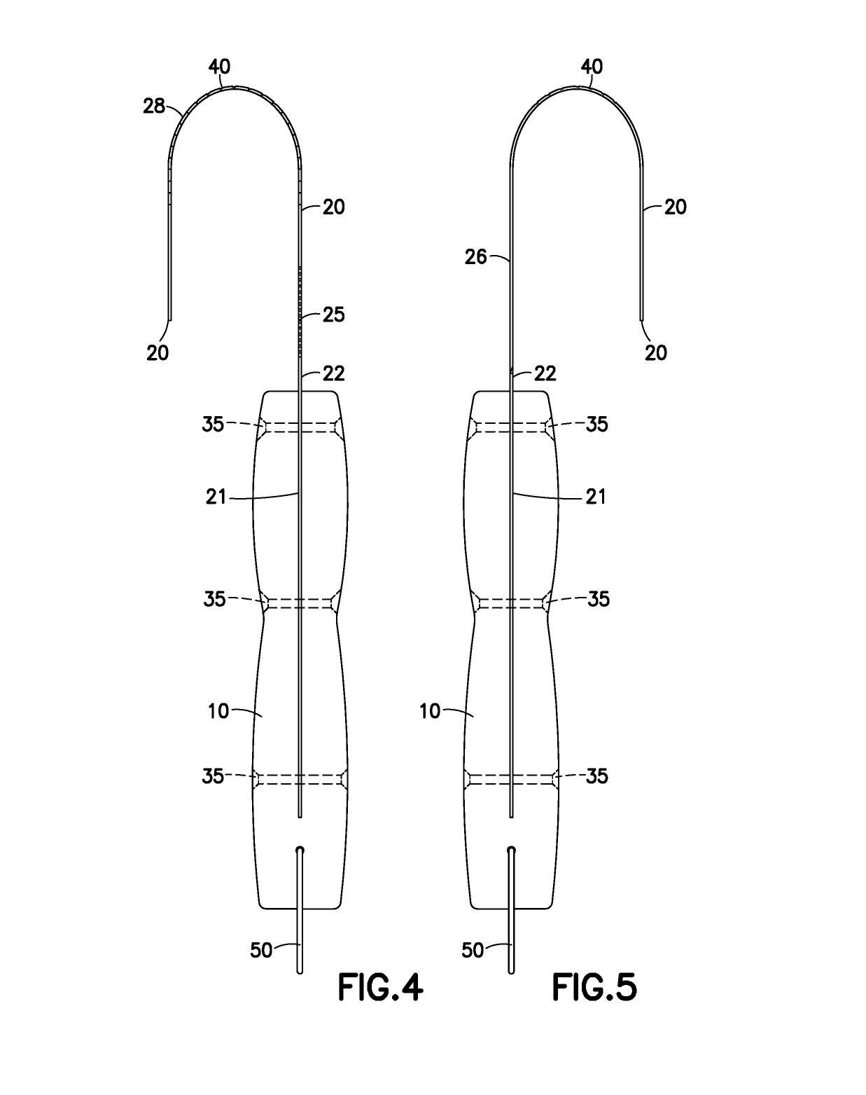

The handle 10 is preferably an elongated, substantially cylindrical handle, preferably with slight concave curvature towards the center (double concave if viewed in the cross-section along the vertical center axis), although the curvature may be convex as well. There is a groove inside the handle 10 shaped and sized to accept the blade 20. The groove accepts the tang 21 of the blade 20 with a cap 30 being threaded onto the tang 21, all the way up to the base 22 of the blade 20. The tang 21 of the blade 20 is then inserted into the grove in the handle 10 and secured in place by the cap 30, which is preferably stainless steel or another suitable material. The handle 10 is shaped so as to accommodate a wide variety of hand shapes and sizes. The preferred length of the handle 10 is five inches (5″), but it may be shorter or longer as needed. In an alternative embodiment illustrated in FIG. 2-5, the tang 21 may be held in the handle 10 by rivets 35, which are the securing means in this embodiment.

As further illustrated in FIG. 1-5, the blade 20 curves approximately in the middle. The preferred curvature of the blade 20 is defined by the preferred distance between the end 24 and the blade 20, which preferred distance is two and a half inches (2½″). This preferred distance defines the arc of a circle, 2½″ in diameter, which is the curvature of the blade 20 (a semi-circle of 2½″ diameter). Outside of the curved area, the two ends of the blade 20, the end 24 and the base 22 are substantially parallel to each other. It should be noted that the arc of the circle is the preferred curvature of the blade 20, but the curvature may be elliptical or otherwise.

The blade 20 also preferably flares (becomes wider) further away from the base 22 until it reaches the desired width, and then the left and right sides of the blade 20 (latitudinal edges) are substantially parallel. The end 24 of the blade 20 is preferably rounded. The blade 20 has a cutting edge 26 running along all or part of the blade 20, and on the opposite side of the blade 20 there are curls 28 running a substantial length of the blade 20, and a small scraper 25. A peeler 40 is located on the blade 20, approximately where the blade 20 curves.

A ring or loop 50 for hanging the device of the present invention on a tool board or from the countertop is preferably attached to the end of the handle opposite to the blade 20 as illustrated in FIGS. 1-5. The ring or loop 50 may be metal, plastic, or it may be built or molded into the handle 10.

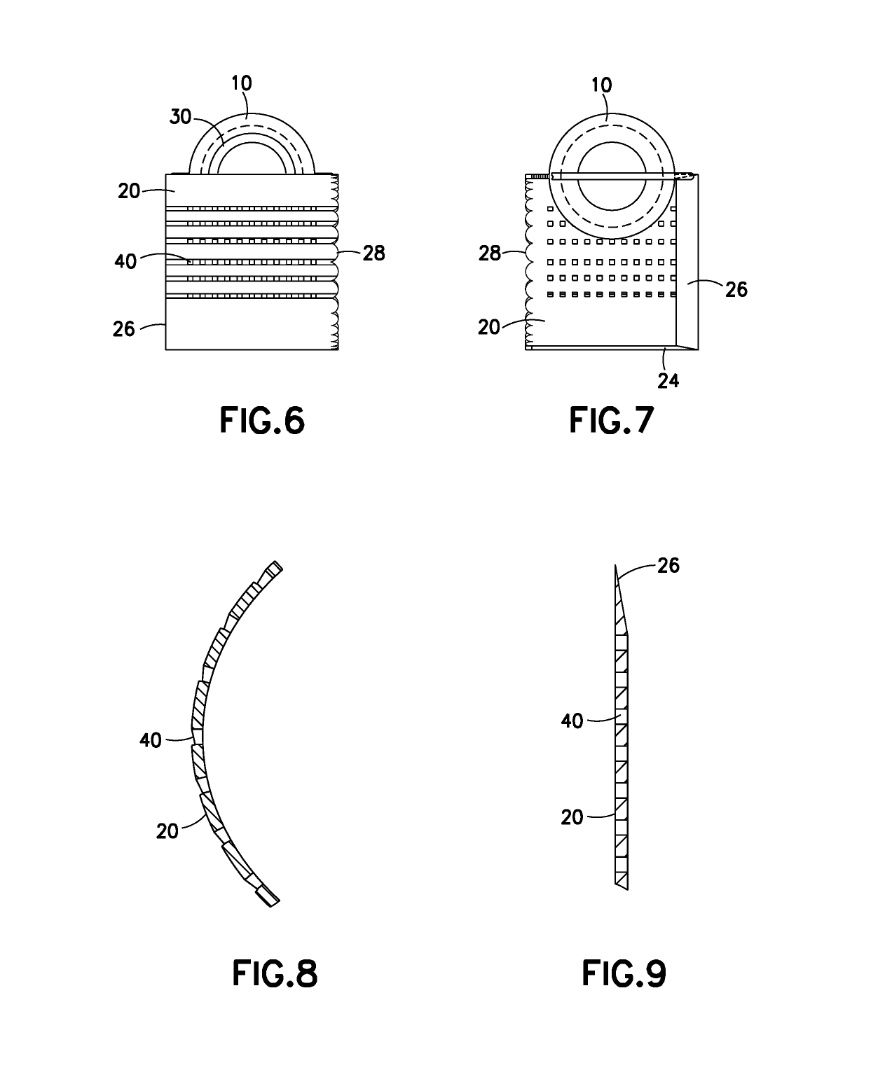

With reference to FIG. 6-8, the peeler is located between the curls 28 and the cutting edge 26 of the blade 20. The peeler 40 may be stamped into the blade 20 or it may machined during the manufacture of the blade 20. If the material used for the blade 20 is other than metal (i.e., ceramic), the elements of the blade will have to be formed during the manufacture of the blade 20.

The utensil of the present invention serves multiple purposes: it allows the user of the present invention to make the chocolate flowers to decorate any cake of a desired shape, size, and content, and the utensil may also be used as a cutting utensil or peeper/zester when needed.

The chocolate is preferably of a hard consistency before making the flowers because that facilitates a better cutting and formation of the chocolate flowers and ensures a more uniform consistency of the flowers by making the thickness of the cut uniform. The user takes the utensil of the present invention by the handle, the convex or concave curvature of which helps retain the handle in the user's hand, and begins cutting the chocolate block multiple times, curving and folding the thin, long shreds and shavings of chocolate, shaping them into circular chocolate flowers. The cutting edge on the right side of the blade and the curls/scraper on the left side of the blade assist the user in selecting and shaping the texture of the flower “petals” as they are seen from the top (straight or ruffled). Once the chocolate flowers are completed, it is preferably to drip melted chocolate on top and on the sides of the chocolate flowers to cement the flowers together. Then, the cake can be decorated with the clusters of chocolate flowers. The cake with the chocolate flowers may be later placed into the refrigerator to solidify the chocolate before serving, transporting, etc. the decorated cake.

The handle 10 is preferably made from food-grade plastic or polymer, and may be injection molded or otherwise manufactured as known in the art. Other food-safe, suitable materials and compounds may also be used to make the handle 10, such as stainless steel, wood, and polycarbonate. The corners and the edges of the handle 10 are preferably rounded and/or smoothed so as to avoid any cut or other injury to the user. The blade 20 is preferably made of stainless still, but it could also be ceramic or use other materials known in the art.

The above description of the disclosed preferred embodiments is provided to enable any person skilled in the art to make or use the invention. Various modifications to these embodiments will be readily apparent to those skilled in the art, and the principles described herein can be applied to other embodiments without departing from the spirit or scope of the invention and the subject matter of the present invention, which is broadly contemplated by the Applicant. The scope of the present invention fully encompasses other embodiments that may be or become obvious to those skilled in the art.

What is claimed is:

1. A combination utensil for making chocolate flowers, comprising:
a. an elongated handle adapted to be graspable by hand, said elongated handle having a proximate end and a distal end and defining a groove in the elongated handle at the proximate end; and
b. a substantially flat blade mounted in the groove and extending from the elongated handle, said blade having a back surface and a front surface with a base end extending from the elongated handle and a tip end, defining a curved longitudinal axis therebetween, the blade flaring outwards from the base end of the blade and curving semi-circularly defining a distance between the base end and the tip end, said tip end extending downwardly towards the elongated handle, said blade having a left side and a right side with a sharpened edge, wherein the tip end and the base end of the front surface are substantially parallel to each other outside of an arc of a circle curvature, and wherein said blade includes a peeler grate on a part of the back surface of the blade curving semi-circularly, said peeler grate comprising a plurality of rows of at least three adjacent apertures in each row transversely-aligned across the curved longitudinal axis.

2. The combination utensil of claim 1, wherein the elongated handle is substantially cylindrical.

3. The combination utensil of claim 2, wherein the elongated handle has a longitudinal concave curvature.

4. The combination utensil of claim 1, wherein the distance from the base end to the tip end is two and a half inches.

5. The combination utensil of claim 1, wherein the blade is removably mounted in the elongated handle.

6. The combination utensil of claim 1, wherein the blade includes a plurality of curls on the left side of the blade, said curls being disposed between the base end and the tip end along the blade.

7. The combination utensil of claim 1, wherein the blade includes a scraper comprising a plurality of teeth on the left side of the blade, said scraper being disposed between the base end and the tip end.

8. The combination utensil of claim 7, wherein the scraper is serrated.

9. (canceled)

10. The combination utensil of claim 1, further comprising a ring attached to the distal end of the elongated handle for hanging the combination utensil.

11. The combination utensil of claim 1, wherein the blade includes a tang inserted into the groove to hold the blade in the elongated handle.

12. The combination utensil of claim 1, further comprising securing means to hold the blade in the elongated handle selected from the group consisting from a cap mounted between the elongated handle and the blade, bolts, rivets, screws, and snaps.

13. (canceled)

14. (canceled)

15. The combination utensil of claim 12, wherein the securing means is further adapted to enable the removal or replacement of the blade.

16. (canceled)
